(19) United States
(12) Patent Application Publication
(10) Pub. No.: US 2007/0133217 A1
(43) Pub. Date: Jun. 14, 2007

(54) Modular storage bin for vehicle

(75) Inventors: John M. Tiesler, Harrison Twp., MI (US); Chris Pattitoni, Northville, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/301,899

(22) Filed: Dec. 13, 2005

(51) Int. Cl. B60Q 1/00

(52) U.S. Cl. 362/459

(57) ABSTRACT

An overhead storage bin comprises a storage bin bezel, a door movable in relation to the storage bin bezel between a closed position and an opened position, a storage compartment accessible by a vehicle passenger when the door is in the opened position, and a lamp carried by the storage bin bezel, the lamp being focused to the storage compartment when the door is in the open position.

### BACKGROUND OF INVENTION

The present invention relates to interior vehicle assemblies and consoles. More particularly, the present invention relates to a modular storage bin for use with a powerstrip within a configurable module console of a vehicle.

Modern vehicles typically include an overhead console assembly. The overhead console assembly is generally an elongated structure disposed along a center longitudinal axis of a headliner. The headliner includes an upper surface mounted to an interior roof structure of the vehicle and a lower surface having an overlay applied thereon. The overhead console assembly is mounted to the lower surface and provides additional storage space for items, such as eyeglasses, garage door openers, audio cassettes, and compact discs. The overhead console assembly also may provide amenities or electronic accessories, such as overhead lights, heating, ventilation, and air-conditioning system (HVAC) controls, audio and video displays and controls, compasses, and temperature displays.

Overhead console assemblies have evolved to support a series of modules for storing and containing the above-stated items and accessories. Such modules are typically limited in use in that they are incapable of being repositioned relative to each other without completely rebuilding the console assemblies. Fixed modules restrict passengers from rearranging the position of the modules based on driver and passenger preferences.

Modular overhead console assemblies have been created to allow for physical relocating of overhead storage modules. Some assemblies even permit electronic modules to be relocated. However, such assemblies do not address the need to direct light to items and accessories stored in storage modules without illuminating the entire vehicle.

Thus, there exists a need for an improved configurable module console that allows for the relocating or repositioning of a modular storage bin and the provision of light directly to the storage bin without illuminating the entire vehicle.

### SUMMARY OF INVENTION

The present invention is directed towards an overhead storage bin for a vehicle that meets the foregoing needs. The overhead storage bin according to an exemplary embodiment of the invention comprises a storage bin bezel, a door movable in relation to the storage bin bezel between a closed position and an opened position, a storage compartment accessible by a vehicle passenger when the door is in the opened position, and a lamp carried by the storage bin bezel, the lamp being focused to the storage compartment when the door is in the open position.

Various objects and advantages of this invention will become apparent to those skilled in the art from the following detailed description of the preferred embodiment, when read in light of the accompanying drawings.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a bottom, rear perspective view of a modular storage bin in accordance with an embodiment of the present invention and powerstrip of a vehicle;

FIG. 2 is a front perspective view of the modular storage bin and the powerstrip shown in FIG. 1;

FIG. 3 is a partial sectional elevational view of the modular storage bin and the powerstrip shown in FIGS. 1 and 2;

FIG. 4 is a partial sectional exploded rear perspective view of the modular storage bin and a lamp module bezel for support therein;

FIG. 5 is a front perspective view of the lamp module bezel shown in FIG. 4 and a switch paddle supported for pivotal movement relative to the lamp module bezel.

FIG. 6 is an exploded partial front perspective view of the lamp module bezel and the switch paddle shown in FIG. 5.

FIGS. 7 and 8 are partial sectional side perspective views of the modular storage bin and the powerstrip shown in FIGS. 1-3, with the modular storage bin door closed and opened, respectively, to make and break a switch contact.

### DETAILED DESCRIPTION

In each of the following figures, the same reference numerals are used to refer to the same components. While the present invention is described primarily with respect to a modular storage bin for use with a powerstrip within a configurable overhead module console for a vehicle, the present invention may be adapted to various vehicle consoles including fore, center, and aft located consoles, and other vehicle consoles known in the art. The present invention may be applied to ground-based vehicles, aeronautical vehicles, watercraft, and other vehicle applications known in the art.

In the following description, various operating parameters and components are described for one constructed embodiment. These specific parameters and components are included as examples and are not meant to be limiting.

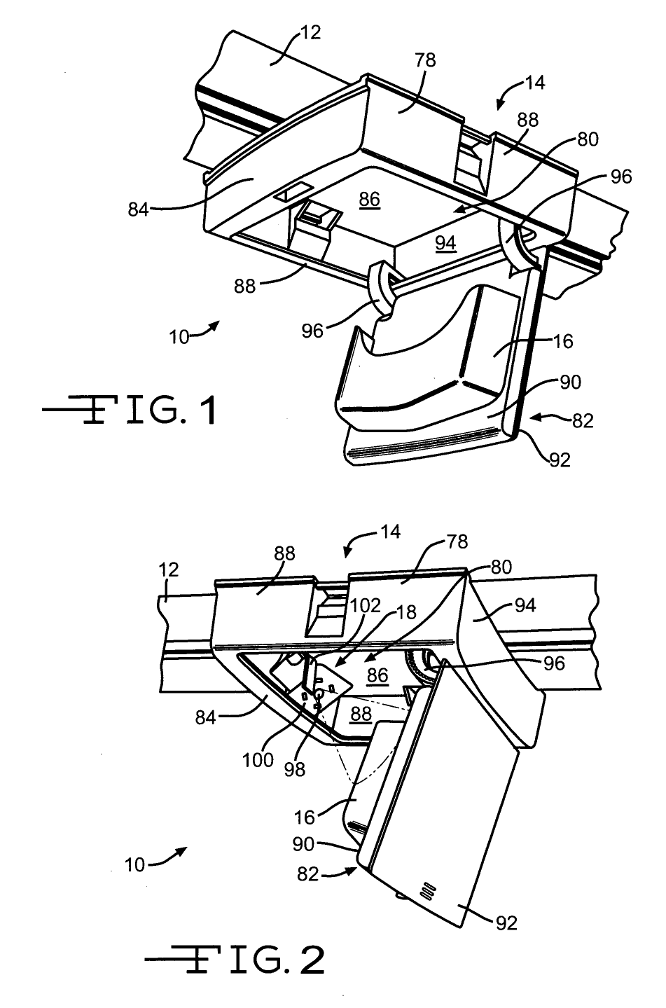

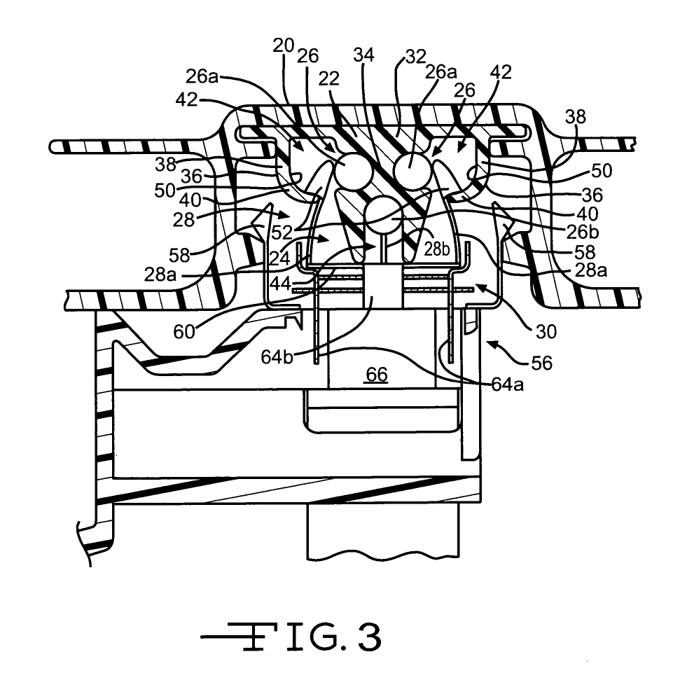

Referring now to FIGS. 1 and 2, partial perspective views of a configurable overhead module console 10 of a vehicle is shown. The overhead console 10 includes a vehicle overhead powerstrip 12 and a modular storage bin 14 in accordance with an embodiment of the present invention. The modular storage bin 14 may be manually removed from the powerstrip 12 and rearranged in various positions relative to the powerstrip 12 and other modules as desired by vehicle passengers. Moreover, the modular storage bin 14 may be moved relative to the powerstrip 12 without losing electrical contact with the powerstrip 12. An example of the powerstrip 12 in cooperation with the modular storage bin 14 is shown in with respect to FIG. 3 and described in detail in the description hereinbelow.

The modular storage bin 14 may be of various types, styles, shapes, and sizes. The modular storage bin 14 may include a storage compartment 16, such as an eyeglass holder, a garage door opener holder, and audio cassette, CD, and DVD holder, as well as other storage compartments known in the art. The modular storage bin 14 may further include a light assembly 18 for casting light on the storage compartment 16.

Referring now to FIG. 3, a partial sectional view of the modular storage bin 14 and the powerstrip 12 of the overhead module console 10 is shown. The overhead module console 10 includes an upper track 20 and a lower track 22. The modular storage bin 14 is rearrangeable on the tracks 20 and 22 and may receive power via the powerstrip 12. The modular storage bin 14 when snapped onto the tracks 20 and 22 is in contact with and may be slid along the powerstrip 12 while maintaining electrical contact therewith.

The overhead module console 10 is shown as one illustrated example, as is the modular storage bin 14, which may be one of a plurality of modular storage bins. The upper track 20 is coupled to the headliner and the vehicle support structure. The vehicle support structure refers to a frame, a unibody, or a body structure of a vehicle. The lower track 22 and the modular storage bin 14 are coupled to the upper track 20. The modular storage bin 14 is coupled to and receives power from the powerstrip 12, which allows it to be in various positions longitudinally along the centerline of the vehicle. The modular storage bin 14 may be in various fore and aft positions within the overhead module console 10.

The powerstrip 12 includes an overhead attachment strip 24, which may be coupled to the upper track 20 or to the support structure. Multiple electrically conductive strips 26 reside within and are coupled to the attachment strip 24 and provide power to electrical contacts 28 of a modular connector 30. The modular connector 30 is coupled to the modular storage bin 14 and may be manually snapped into or coupled to the attachment strip 24. The modular connector 30 has an infinite number of attachment positions along the attachment strip 24.

The attachment strip 24 extends fore and aft longitudinally along the centerline of the vehicle. The attachment strip 24 may be a single extruded component as shown or may be formed of multiple components. The attachment strip 24 may be formed of various materials. In one sample embodiment, the attachment strip 24 includes a base 32 having a main center member 34 and a pair of flanges 36. The base 32 and the flanges 36 are integrally extruded and formed as a single component using techniques known in the art.

The flanges 36 have upper portions 38 and lower portions 40. The lower portions 40 are formed of a flexible material such that they may be deflected to allow insertion of the electrical contacts 28a into the attachment strip 24 and connection with the conductive strips 26a. In the embodiment as shown, the flanges 36 are curled inward toward the main center member 34 and are deflected by and apply pressure on the electrical contacts 28a. The flanges 36 apply pressure on the electrical contacts 28a to aid in maintaining contact between the electrical contacts 28a and the associated conductive strips 26a. The flanges 36 also aid in preventing body parts of a passenger, such as fingers of the passenger, from contacting the conductive strips 26a. The flanges 36 in addition provide an esthetically pleasing look to the overhead module console 10 when overhead modules, such as the modular storage bin 14, are removed therefrom by covering and hiding from passenger view the conductive strips 26a.

The conductive strips 26 also extend fore and aft longitudinally along the centerline of the vehicle. The conductive strips 26 may also be of various types, styles, sizes, and shapes. The conductive strips 26 may be formed at least partially of brass, copper, aluminum, a half hard brass, or some other conductive material known in the art and may be controlled with the attachment strip 24. The conductive strips 26, which are merely exemplary of conducting strips having application with the present invention, include round or cylinder strips, although other shapes, including for example rectangular or flat strips, may be suitable for application with the present invention. The conductive strips 26 may be selected based on ease of manufacturing and availability or commonality thereof.

In the illustrated embodiment of the present invention, two positively charged conductive strips, such as conductive strips 26a, are mounted within vertical recessed portions 42 of the main center member 34. A third negatively or neutrally charged conductive strip 26b, such as a ground strip, a common strip, or a return strip, is coupled horizontally along a groove 44 of the main center member 34. The conductive strips 26b may be adhesively coupled to the main center member 34 or coupled via some other technique known in the art. For example, the conductive strips 26a, 26b may have an attachment tab (not shown) that may be depressed or snapped into a channel of the main center member 34.

The modular connector 30 may have multiple electrical terminals or contacts. In the illustrated embodiment, a pair of contacts 28a extends vertically and is hooked to have spring characteristics. When coupling the contacts 28a to the attachment strip 24, the contacts 28a are inserted into recessed portions or contact channels 42 of the attachment strip 24, through the flanges 36, and are in contact with the conductive strips 26a. The contact channels 42 are formed via channel surfaces 50 of the attachment strip 24 and the conductive strips 26a. Hooked areas 52 of the contacts 28a may be compressed when inserted into the contact channels 42 and may remain at least somewhat compressed or relaxed and in a normal state when in the contact channels 42. When compressed, the contacts 28a may apply additional pressure on the conductive strips 26a. The contacts 28a also may have a physical spreading resistance therebetween, such that the contacts 28a are further separated when inserted into the contact channels 42, again increasing pressure of the contacts 28a on the conductive strips 26a.

The modular connector 30 may also have a vertical ground contact 28b, as shown in the drawing, which is in contact with the ground strip 26b. The modular connector 30 may have any number of contacts and the contacts may be in various configurations, other than that shown in the drawings.

Continuing with reference to FIG. 3, the modular storage bin 14 includes the modular connector 56 and one or more module hanging attachment clips 58. The modular connector 56 is coupled to the modular storage bin 14 in any suitable manner, including but not limited to plastic welding. The hanging attachment clips 58 may be in the form of two-way clips, sometimes referred to as push push clips. Approximately the same amount of pressure is applied to the hanging attachment clips 58 to attach them to the upper track 20 as when removing them from the upper track 20. The hanging attachment clips 58 may be formed of steel or some other rigid material or materials known in the art.

As stated above, the modular connector 30 is irregularly U-shaped. The modular connector 30 has a pair of vertical electrically conductive positive contacts 28a and a vertical ground contact 28b, which are separated by an insulator stack or block 60. The vertical contacts 28a extend within the contact channels 42 and are in contact with the conductive strips 26a. The vertical contacts 28a extend around the sides of and are coupled to the insulator block 60. The vertical contacts 28a are coupled to and may be integrally formed with positive or end terminals 64a. The ground contact 28b is pressed against the ground strip 26b and is coupled to a ground plate 66. The ground plate 66 resides on the insulator block 60 and is coupled to a ground terminal 64b. The ground contact 28b, the ground plate 66, and the ground terminal 64b may be formed as a signal unit as shown or may be separate components. The ground contact 28b extends about the center of the modular connector 30 and curls inward in a fore and aft direction. The ground contact 28b also has spring characteristics such that it is at least partially in compression when in contact with the ground strip 26b. The terminals 64a, 64b extend horizontally and protrude from the modular connector 30. An electrical connector (not shown) may be attached to the terminals 64a and used to supply power to electronic devices, such as the modular storage bin 14.

The contacts 28a, 28b and the terminals 64a, 64b may be formed of conductive materials, including but not limited to spring steel and are zinc plated.

The vertical contacts 28a, 28b, the insulator box 86, and the ground plate 66 may have holes 72 extending therethrough for which module studs or stakes, such as the stakes 74 shown in FIG. 4, may be inserted and attached thereto. The holes 72 may be of various sizes and shapes, which may correspond to the sizes and shapes of the stakes. The holes 72 may also be keyed such that the modular connector 30 can only be coupled to the modular storage bin 14 in one or more desired positions. The module stakes 74 may be plastic welded or attached via some other technique known in the art to the vertical contacts 28a, 28b, the insulator block 60, and the ground plate 66.

Now referring back to FIGS. 1 and 2, the modular storage bin 14 has a bin module bezel 78 with a bottom side opening 80 allowing access to the bin module bezel 78, and also has a door 82 which is arranged pivotably on the bottom front of the bin module bezel 78 and in its closed position, indicated in FIG. 7, closes the opening 80 and in its swung-down position, shown in FIGS. 1 and 2, protrudes downwards and forwards from the opening 80. In this case, the compartment opening 80 on the bottom side of the bin module bezel 78 runs virtually as far as the rear wall 84 of the bin module bezel 78, which rear wall 84 determines the width of the bin module bezel 78. The bin module bezel 78 has a top wall 86 and side walls 88, which determine the length of the bin module bezel 78. The door 82 shown is of double-shell design with the inner shell 90 and the outer shell 92 and a cavity lying in between. The door 82 is coupled to the bin module bezel 78 on both sides in the vicinity of its front wall 94 by means of hinges 96.

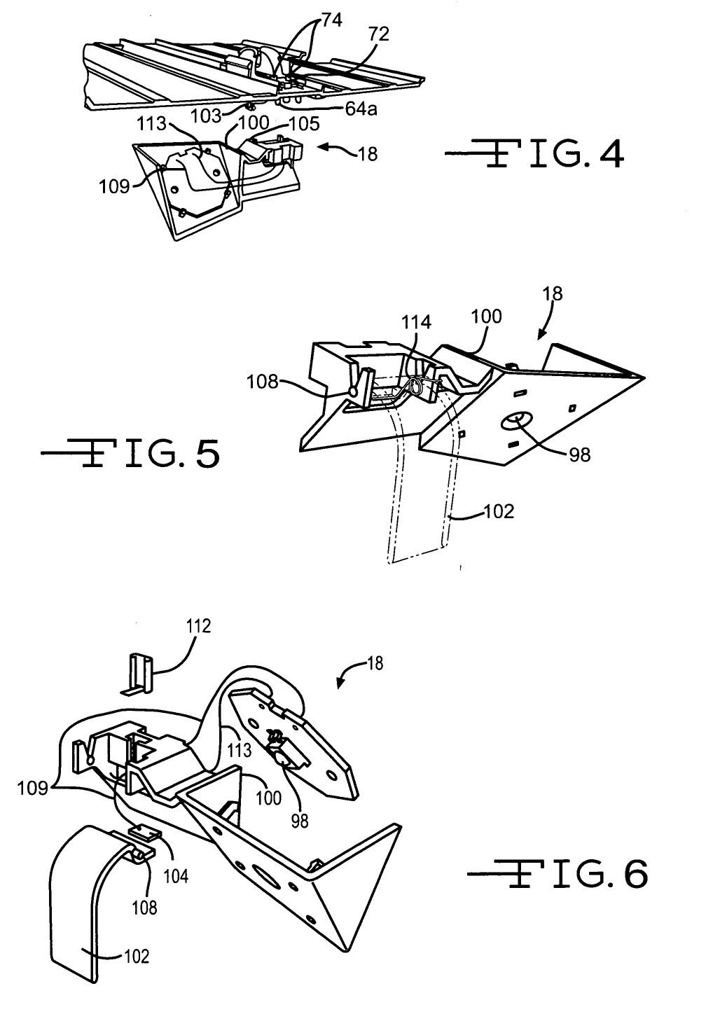

On the top wall 86 there is arranged in the vicinity of the rear wall 84 a downwardly shining lamp 98, which in FIG. 2 is shown to be supported by a lamp module bezel 100, which is in the bin module bezel 78 adjacent and between the inner surface of the top wall 86 and the rear wall 84, and which supports a switch paddle 102. A snap fastener, such as the snap fastener 103 shown in FIG. 4, extending from the top wall 86 passes through a hole 105 in the lamp bezel module 100 to retain the lamp bezel module 100 to the top wall 86. The lamp module bezel 100 and the switch paddle 102 are located so as to be unobtrusive and inconspicuous and lamp module bezel 100 conceals the electric circuit of the lamp 98 so as to provide a wire-free appearance. In the closed position of the door 82, which is indicated in FIG. 7, the switch paddle 102 is pivoted to move an electrical contact 104 of the switch paddle 102, as shown in FIG. 6, as a result of which the electric circuit of the lamp 98 is interrupted.

The lamp 98 is arranged on the inside of the bin module bezel 78 in such a manner that in the swung-down position of the door 82, which is shown in FIGS. 1 and 2, with the bin module bezel 78 opened, the lamp 98 is switched on and light from the lamp 98 is focused to a storage compartment 16 when the door 82 is in a full opened position. A typical path of light beam is indicated by dash-dotted line in FIGS. 1 and 2. In the exemplary embodiment shown, the lamp 98 is designed as an LCD light and is supported by the lamp module bezel 100 in an angularly disposed front wall 106 of the lamp module bezel 100. It should be appreciated that other lamps may be suitable for carrying out the invention and that reflectors and other suitable structure may be configured to focus light from the lamp.

The exemplary switch paddle 102, as shown in the drawings, has an inverted, substantially J-shaped configuration and is supported for pivotal movement relative to the lamp module bezel 100 by pivots 108 that extend transversely from opposing sides of the switch paddle 102, as shown in FIGS. 5 and 6. As shown in FIG. 6, a metal contact 104 is bonded to an upper end of the switch paddle 102 and is electrically connected to one side of the lamp 98 via an electrical conductor 109. The metal contact 110 makes electrical contact with a female spade terminal receiver 112, which is shown in FIG. 6, when the door 82 of the bin module bezel 78 is swung-down. The female spade terminal receiver 112 receives and makes electrical contact with the ground terminal 64b, which in turn makes electrical contact with the negatively charged conductive strip 26b of the powerstrip 12 via the ground contact 28b. The other side of the lamp 98 makes electrical contact with a positively charged conductive strip 26a of the powerstrip 12 through a contact 28a and via one of the positive terminals 64a and via an electrical conductor 113 to complete the electrical circuit and switch on and light the lamp 98 when the door 82 of the bin module bezel 78 is swung-down. As shown in FIG. 5, a spring 114 may be carried by one or both of the pivots 108 and provides a biasing action to pivot the switch paddle 102 in a manner to cause the metal contact 110 to make electrical contact with a female spade terminal receiver 112 when the door 82 of the bin module bezel 78 is swung-down.

The modular storage bin 14, with its door 82 in the closed position, is shown in a partial sectional side perspective view in FIG. 7. With the door 82 closed as shown, the switch paddle 102 is pivoted relative to the lamp module bezel 100 so that the electrical contact 104 breaks contact with the female spade terminal receiver 112, shown in FIG. 6, so as to interrupt the electric circuit of the lamp 98. The modular storage bin 14, with its door 82 in the opened position, is shown in a partial sectional side perspective view in FIG. 8. With the door 82 opened as shown, the switch paddle 102 is biased by the return spring 114 so as to be pivoted relative to the lamp module bezel 100 so that the electrical contact 104 makes contact with the female spade terminal receiver 112 so that the lamp 98 is switched on and light from the lamp 98 is focused to a storage compartment 16.

The present invention provides a vehicle overhead module powerstrip that allows for rearrangement of overhead modules within an overhead console without rebuilding the console. The powerstrip allows electronic modules to be repositioned in an infinite number of positions along an overhead console. The present invention provides multiple features to maintain electrical contact between the module and power strip assembly and also accounts for esthetic satisfaction of and prevents electrical physical contact with a vehicle passenger. In accordance with the present invention, the module can be moved along the powerstrip with its contact points hidden and without breaking electrical contact with the powerstrip, even with the door open and the lamp on, and may be locked in place with a lock assembly, such as the console latch assembly described in U.S. patent application Ser. No. 10/946,712, to Lear Corporation, filed on Sep. 22, 2004, the description of which is incorporated herein by reference.

The principle and mode of operation of this invention have been explained and illustrated in its preferred embodiment. However, it must be understood that this invention may be practiced otherwise than as specifically explained and illustrated without departing from its spirit or scope.

1. An overhead storage bin for a vehicle comprising:
a storage bin bezel having a plurality of walls defining an interior storage space;
a door supported on the storage bin bezel and movable in relation to the storage bin bezel between a closed position to close the interior space and an opened position to expose the interior space;
a storage compartment supported on the door and accessible by a vehicle passenger when the door is in the opened position; and
a lamp fixed to the storage bin bezel within the interior space, the lamp being focused to direct light onto the storage compartment when the door is in the open position.

2. The overhead storage bin of claim 1, wherein the lamp is an LCD lamp.

3. The overhead storage bin of claim 1, wherein the plurality of walls includes a front wall and a rear wall, the door being coupled to the bin module bezel in the vicinity of the front wall by means of at least one hinge, the lamp being arranged in a vicinity of the rear wall and shines downwardly on the storage compartment when the door is in the open position.

4. The overhead storage bin of claim 1, wherein the lamp is controlled by a switch paddle that, when the door is in the opened positions causes the lamp to light.

5. The overhead storage bin of claim 4, further comprising a return spring biasing the switch paddle to cause the lamp to switch on when the door is in the opened position.

6. The overhead storage bin of claim 4, further comprising a lamp module bezel supporting the lamp and supporting the switch paddle for pivotal movement.

7. The overhead storage bin of claim 1, wherein the storage bin bezel is supported for movement along a powerstrip that makes electrical contact with the lamp, the storage bin bezel being movable along the powerstrip without breaking the electrical contact between the powerstrip and the lamp.

8. A configurable overhead module console comprising:
a track configured to be mounted in a motor vehicle, the track being connected to a power source;
a modular storage bin supported for movement in relation to the track, the modular storage bin having a plurality of walls defining an interior storage space;
a door supported on the modular storage bin for movement in relation to the modular storage bin between an opened position to expose the interior space and a closed position to close the interior space;
a storage compartment supported by the door and accessible to a passenger of the vehicle when the door is in the opened position;
a light fixed to the modular storage bin within the interior space and connected the power source through the track, the light being focused to direct light onto the storage compartment supported by the door when the door is in the opened position, the light remaining connected to the power source when the compartment is moved relative to the track.

9. The configurable overhead module console of claim 8, wherein the lamp is an LCD lamp.

10. The configurable overhead module console of claim 8, wherein the plurality of walls includes a front wall and a rear wall, the door being coupled to the bin module bezel in the vicinity of the front wall by means of at least one hinge, the lamp being arranged in a vicinity of the rear wall and shines downwardly on the storage compartment when the door is in the open position.

11. The configurable overhead module console of claim 8, wherein the lamp is controlled by a switch paddle, which when the door is in the opened position causes the lamp to light.

12. The configurable overhead module console of claim 11, further comprising a return spring biasing the switch paddle to cause the lamp to move to an on position when the door is in the opened position.

13. The configurable overhead module console of claim 11, further comprising a lamp module bezel supporting the lamp and supporting the switch paddle for pivotal movement.

14. A configurable overhead module console comprising:
a track configured to be mounted overhead in a motor vehicle, the track being connected to a power source;
a modular storage bin supported for movement in relation to the track the modular storage bin having a plurality of walls defining an interior storage space;
a door supported on the modular storage bin for movement relative to the modular storage bin between an opened position to expose the space and a closed position to close the interior space;
a storage compartment supported by the door and accessible by a passenger of the vehicle when the door is in the opened position;
a light fixed to the modular storage bin within the interior space and connected the power source through the track, the light maintaining the connection to the power source when the compartment is moved relative to the track, the light being focused to direct light onto the storage compartment when the door is in the opened position; and
a switch that activates the light when the door is in the opened position and deactivates the light when the door is in the closed position.
